(19) United States
(12) Patent Application Publication
(10) Pub. No.: US 2024/0102450 A1
(43) Pub. Date: Mar. 28, 2024

(54) AN APPARATUS FOR AND A METHOD OF BALANCING A TRAVELLING CAR FOR INSTALLATION OF AT LEAST A PART OF A WIND TURBINE

(71) Applicant: Nekkar ASA, KRISTIANSAND S (NO)

(72) Inventors: Yngvar BORØ, SØGNE (NO); Ricardo Nuno CORREIA, FLEKKERØY (NO); Adrian Mihai ORASANU, FLEKKERØY (NO); Arild ANDERSEN, KRISTIANSAND (NO)

(73) Assignee: Nekkar ASA, KRISTIANSAND S (NO)

(21) Appl. No.: 18/265,952

(22) PCT Filed: Dec. 9, 2021
(86) PCT No.: PCT/NO2021/050255

§ 371 Date: Jun. 7, 2023

(30) Foreign Application Priority Data
Dec. 11, 2020 (NO) 20201367

(51) Int. Cl. F03D 13/10

(52) U.S. Cl. CPC F03D 13/139; F03D 13/112; E04H 12/34

(57) ABSTRACT

An apparatus is for performing a part of an operation to install a tower for a wind turbine, wherein the wind turbine has a tower, wherein the apparatus has a travelling car for travelling up and down along the tower of the wind turbine and for carrying an item to be installed as part of the wind turbine, wherein the travelling car has a device for balancing the travelling car, and wherein the device for balancing the travelling car has a weight configured to be movably connected to the travelling car i) for allowing keeping the travelling car balanced under exposure to a force or ii) for avoiding, correcting or reducing a shift in a centre of gravity of the travelling car. Further is disclosed a method of balancing a travelling car for an apparatus for performing at least a part of an operation to install a wind turbine.

### CROSS-REFERENCE TO RELATED APPLICATIONS

This application is the U.S. national stage application of International Application PCT/NO2021/050255, filed Dec. 9, 2021, which international application was published on Jun. 16, 2022, as International Publication WO 2022/124908 in the English language. The International Application claims priority of Norwegian Patent Application No. 20201367, filed Dec. 11, 2020. The international application and Norwegian application are both incorporated herein by reference, in entirety

### FIELD

The current invention relates to an apparatus for and a method of balancing a travelling car for installation of at least a part of a wind turbine.

### BACKGROUND

The invention relates to the technical field of wind turbines, and more specifically to installation of wind turbines.

To more efficiently harvest electrical power from the wind, it is desirable to make wind turbines very tall. In fact, the industry is actively working to develop cost-efficient and practical ways to allow wind turbines to become taller.

One challenging factor, as wind turbines grow taller, is the installation process, and the methods and apparatuses needed to successfully install very tall wind turbines.

Traditionally, wind turbines are installed by use of giant cranes that lifts parts of the wind turbines, including sections of a tower, a nacelle and blades, to install the parts. The cranes are gigantic, and it requires a lot of work and significant infrastructure to get the cranes to location and to install them, before even starting to install the wind turbines themselves. Just delivering the parts of a crane to an installation site may require some 80 semi-trailers. Furthermore, it may be very challenging, and require friendly weather, to install parts of the wind turbine, particularly the uppermost parts, when they are lifted by a crane separate from the tower, e.g. because of relative movement of the crane and the tower.

### SUMMARY

The invention is defined by the independent patent claims. The dependent claims define advantageous embodiments of the invention.

In a first aspect, the invention relates to an apparatus for performing a part of an operation to install a wind turbine, wherein the apparatus comprises a travelling car for travelling up and down along a tower of the wind turbine and for carrying an item to be installed as part of the wind turbine, wherein the travelling car comprises a device for balancing the travelling car, and wherein the device for balancing the travelling car comprises a weight configured to be movably connected to the travelling car i) for allowing keeping the travelling car balanced under exposure to a force or ii) for avoiding, correcting or reducing a shift in a centre of gravity of the travelling car, wherein the device for balancing the travelling car comprises a plurality of weights and wherein at least one weight is movably connected to each one of a plurality of drive systems arranged along at least two of an x-axis, a y-axis and a z-axis, wherein the x-axis is a substantially horizontal axis, the y-axis is a substantially vertical axis and the z-axis is a substantially horizontal axis substantially perpendicular to the x-axis when the apparatus is in operational use.

The shift in centre of gravity of the travelling car may be caused by e.g. a movement of a part of the travelling car and/or a movement or removal of an item carried or addition of an item to be carried by the travelling car. The force may be e.g. a gravitational force, a wind force or a wave force.

The weight may be a counterweight. The weight may be of a solid material. The weight may be a heavy metal weight, or made from another material with relatively high density, such as a density of more than 5 g/cm³. The weight may e.g. be a steel weight.

The weight may be movably mounted to the travelling car via a track of a drive system.

The apparatus may comprise a rack and pinion drive system. The weight may be configured to be movably connected to the travelling car via the rack and pinion drive system. Alternatively, the apparatus may comprise a track and wheel system. The weight may be configured to be movably connected to the travelling car via the track and wheel system. Another type of drive system suitable for the purpose may be used.

The apparatus comprises a plurality of weights, such as two, three, four or even more than four weights, that may be configured to be movably connected to one or more drive systems. The apparatus may comprise a plurality of drive systems. There may be one drive system per weight, or one or more drive systems may be configured to receive more than one weight.

The apparatus may comprise a drive system arranged for a weight to move along an axis. The apparatus may comprise one or more drive systems that are arranged to move one or more weights along a first and a second axis. The apparatus may comprise one or more drive systems that are arranged to move one or more weights along a first, a second and a third axis.

In one possible embodiment, in operational use, the apparatus has a weight movably connected to the travelling car via a respective rack and pinion drive system arranged for the weight to be moved along a substantially horizontal x-axis. In a second possible embodiment, in operational use, the apparatus has a first weight movably connected to the travelling car via a respective first rack and pinion drive system arranged for the weight to be moved along a substantially horizontal x-axis and a second weight movably connected to the travelling car via a respective second rack and pinion drive system arranged for the weight to be moved along a substantially vertical y-axis. In a third possible embodiment, in operational use, the apparatus has a first weight movably connected to the travelling car via a respective first rack and pinion drive system arranged for the first weight to be moved along a substantially horizontal x-axis, a second weight movably connected to the travelling car via a respective second rack and pinion drive system arranged for the second weight to be moved along a substantially vertical y-axis and a third weight movably connected to the travelling car via a respective third rack and pinion drive system arranged for the third weight to be moved along a substantially horizontal z-axis, substantially perpendicular to the x-axis. More weights and the ability to move weights along a plurality of axis may be advantageous to increase the accuracy of the device for balancing the travelling car. Furthermore, it may facilitate improved balancing of the travelling car e.g. that may be particularly well suited against motions from more complex forces such as wind or waves affecting the tower/wind turbine.

The device for balancing the travelling car may comprise a force-altering device, the force-altering device being a device for altering the direction, the magnitude of or the position from which a force acts on the travelling car. The force-altering device may comprise the weight or weights and the drive system or systems. Additionally, the force-altering device may include one or more winches that may be arranged to reduce or increase a pulling force acting on the travelling car. Alternatively, or additionally, e.g. a winch or a lifting lug may be arranged to be moved to alter a direction of a force or a position of which a pulling force acts on the travelling car. Other force-altering devices are conceivable.

The device for balancing the travelling car may further comprise a device for obtaining information relevant for balancing of the travelling car. The device for obtaining the information relevant for balancing of the travelling car may comprise e.g. a motion reference units, an electronic level, an accelerometer, an anemometer, and/or a force gauge and/or one or more other such equipment. The device for obtaining the information relevant for balancing of the travelling car may comprise one or more of any of the above-mentioned equipment.

The device for obtaining information relevant for balancing of the travelling car may e.g. be used to obtain information regarding carrying load of the travelling car, position of carried load, pull of wire on a pulley or a lifting lug, wind load on the travelling car, movement of the travelling car, level of the travelling car, and/or more. Obtaining such information is highly advantageous to determine a correct action to balance the travelling car. The correct action may e.g. be a movement of a weight in a direction along an axis.

The device for balancing the travelling car may further comprise a controller for controlling the force-altering device. The controller may be e.g. a programmable logic controller or any other computer device or other device capable of receiving input and producing output based on said input to send a controller signal for controlling the force-altering device. The controller may be arranged to fully automatically or semi-automatically control the force-altering device, or to require the input from a human operator to control the force-altering device or one or more parts of the force-altering device. The controller may be configured to receive input from the device for obtaining information relevant for balancing of the travelling car, and to communicate that input to a computer device having a user interface for the human operator and/or to use the information in the automatic or semi-automatic controlling of the force-altering device. The device for obtaining information relevant for balancing of the travelling car may be connected to the controller. The controller may be connected to a user interface for the human operator. The controller may be connected to an input device that may allow the human operator to provide input for the controller. The controller may be configured to use the input provided by the operator to control the force-altering device, and/or to use the input provided by the operator in combination with the input provided by the device for obtaining information relevant for balancing of the travelling car to control the force-altering device, and/or to use the input provided by the device for obtaining information relevant for balancing the travelling car only to control the force-altering device. The apparatus may comprise the computer device having the user interface.

The apparatus may comprise a device for selectively raising or lowering the travelling car.

The wind turbine may comprise a tower that comprises a plurality of sections. Installation of the tower of the wind turbine may include stacking the sections. During an installation of the wind turbine, the tower may comprise an installed part. The tower may comprise an uppermost installed section of the tower.

The device for selectively raising or lowering the travelling car may be arranged to connect the travelling car to an uppermost installed section of the tower.

The plurality of sections may be configured to be installed in a predetermined order. The uppermost installed section of the tower may be the latest installed section at any given time from a certain first point of the installation to a certain second point of the installation. The first point of the installation may be a start of the installation, the second point be an end of the installation. The first point may be any point between the start of the installation of the tower and the second point of the installation, and the second point may be any point between the first point of the installation and the end of the installation.

The installation may include installation of e.g. a nacelle, one or more blades for the wind turbine, and more. The installation may include installing a foundation and/or a base section of the tower. The apparatus may be an apparatus for performing parts of the installation. Typically, it may be necessary to install the foundation and/or the base section of the tower for the apparatus to be used subsequently for further installation of the tower from that point on. The first point of the installation may typically be a point wherein the foundation and/or the base section of the tower has been installed.

“Stacking” sections refers to placing the sections one on top of another: A first section is installed first, a second section is placed on top of the first, a third section is then placed on top of the second, a fourth section is then placed on top of the third, and so on.

The device for selectively raising or lowering the travelling car may typically be controlled by an operator. In some embodiments, the travelling car may be selectively raised or lowered automatically, controlled by a logic controller, or semi-automatically. If controlled automatically, it may e.g. be lowered after a certain time, as a result of performing an action, as a result of reduction of a load on the travelling car, or a combination of any of the mentioned factors.

The travelling car may comprise a platform for carrying one or more sections of the tower. The platform may also be configured for carrying e.g. a nacelle and/or one or more blades for a wind turbine, and/or other items. The platform may be an unmanned platform.

The apparatus may be an apparatus for performing parts of an operation to install a wind turbine. The apparatus may be e.g. for installing a plurality of sections of a tower, for installing a rotor, for installing a nacelle, and/or for installing one or more rotor blades.

The device for selectively raising or lowering the travelling car may comprise a plurality of winches, and/or a plurality of load-bearing ropes for connecting the travelling car to the uppermost section of the tower, and/or a plurality of lifting lugs. In an embodiment, the device for selectively raising or lowering the travelling car may comprise a plurality of winches, a plurality of load-bearing ropes and a plurality of lifting lugs. The lifting lugs may be arranged in connection with an upper portion or side of the uppermost installed section of the tower. The tower sections may comprise lifting lugs The load-bearing ropes may connect the plurality of winches to a plurality of lifting lugs, such that the winches can be used to raise the travelling car or to lower the travelling car. The travelling car may comprise the winches. The device for selectively raising or lowering the travelling car may e.g. be arranged to connect the travelling car to an uppermost installed section of the tower by connecting a plurality of winches of the travelling car to a plurality of lifting lugs placed on an upper surface of the uppermost section of the tower via the plurality of load-bearing ropes. The load-bearing ropes may be any type of line or lengthy connection means for connecting a winch to an object, such as e.g. a wire rope, a fibre rope, a chain, a wire or a rope suitable for its purpose in carrying and moving the travelling car.

In an alternative embodiment, the lifting lugs may be arranged in connection with a side wall of the uppermost section. In such an embodiment, however, the travelling car may have to be configured to move a carried item above the lifting lugs. This may be done e.g. by having a lifting device on the travelling car or by having the deck of the travelling car above a point where the load-bearing ropes are connected to the travelling car.

In alternative embodiments, the device for selectively raising or lowering the travelling car may comprise a plurality of pulleys. In one embodiment, the travelling car may comprise a plurality of lifting lugs, the plurality of pulleys may be arranged in connection with an upper side of the uppermost section of the tower, and the winches may e.g. be arranged in connection with a bottom of the tower. The load-bearing ropes may then extend from the winches to the lifting lugs via the pulleys, to raise or lower the travelling car along the tower. Further alternative embodiments with winches to drive the raising or lowering of the travelling car are possible.

The apparatus may comprise one or more flanges, like an adapter flange, or a sort of bracket, that may comprise one or more lifting lugs. In an embodiment, the apparatus may comprise an adapter flange having a plurality of lifting lugs, the adapter flange being configured to be attached to the top of a section for the tower for the wind turbine. Alternatively, in an embodiment wherein pulleys are arranged in connection with an upper side of a section of the tower, the flange or bracket or similar may comprise one or more pulleys.

The platform may be an unmanned platform.

Furthermore, the platform may be configured for carrying one item to be installed or for carrying a plurality of items to be installed. Embodiments of the apparatus may comprise a platform that is configured for carrying two items. An item may be e.g. a section of the tower, a nacelle, a blade for the rotor, or other pieces of a wind turbine to be installed as the wind turbine is being raised and/or completed.

The platform may comprise a movable deck. The movable deck may be e.g. slidable or rollable, configured to move horizontally along a floor of the platform. The movable deck may be configured for carrying an item as defined in the previous paragraph. Embodiments of the platform may comprise a plurality of movable portions of a deck, wherein one or more or all of the movable portions of the deck are configured for carrying an item.

In one embodiment, the platform may have one movable portion of the deck, for carrying one item. In another embodiment, the platform may have one movable portion, wherein the movable portion is configured for carrying more than one item, e.g. two or three or more items. In yet another embodiment, the platform may have a plurality of movable portions of the deck, e.g. two or three or four movable portions, wherein each portion may be configured for carrying one item or more than one item. Platforms having a plurality of movable portions of the deck may have movable portions arranged to move in different directions from each other, e.g. perpendicularly or e.g. in opposite directions. The movable portions of the deck may be movable from a first, carrying position, which may be considered a default position of the movable portion when the movable portion is carrying an item to be installed, to a second, installation position, a position that the movable portion of the deck is moved to for installation of the item. An embodiment of the apparatus may have a first movable portion of the deck that moves in a first direction when moving from the carrying position to the installation position, and a second movable portion of the deck that moves in a second direction, opposite of the first direction, when moving from its carrying position to its installation position. An embodiment may further have a third movable portion of the deck that moves in a third direction, perpendicular to the first and the second direction, when moving from its carrying position to its installation position.

The apparatus may comprise a device for moving the movable portion or portions of the deck. A skilled person will understand that there are many possible configurations for such a device. One example of such a configuration is a device comprising a motor, configured to be connected to a power source to receive power from said power source, and further being configured to be connected to the movable portion or portions of the deck for moving the movable portion or portions of the deck.

The apparatus may comprise a rack and pinion drive system for the movable portion of deck. The movable portion of the deck may be configured to be movably connected to the rack and pinion drive system for the movable portion of the deck. Alternatively, the apparatus may comprise a track and wheel system for the movable deck. The movable portion of the deck may be configured to be movably connected to the track and wheel system. Another type of drive system suitable for the purpose may be used.

The apparatus/the travelling car may comprise a guiding device for guiding the travelling car along the tower. The guiding device may comprise a plurality of arms with wheels configured for holding the travelling car correctly placed around the tower when raised or lowered along the tower. Other guiding devices are conceivable, such as a guiding device comprising a belt and a slide plate.

The apparatus/the travelling car may comprise a releasable locking device for selectively locking the travelling car in a position on the tower, for keeping the travelling car from moving from the position. The travelling car may be, by use of the releasable locking device, releasably lockable in a position near a top of an installed part of the tower, e.g. to stay in the position while releasing a connection to a previously uppermost section of the tower after the installation of a current uppermost section of the tower and while connecting to the current uppermost section of the tower.

Following the installation of a section of the tower that installed section becomes the uppermost section. The previous uppermost section then becomes the second uppermost section. Following said installation, the travelling car may e.g. be lowered a distance that may be a short distance, and then locked in position by use of the releasable locking device.

To continue with the installation, the travelling car may then be connected to the newly installed, now uppermost section of the tower. This may be done by use of a rope catching device for catching the load-bearing rope and for pulling the load-bearing rope to an upper position of the uppermost section of the tower. The rope catching device may comprise e.g. a winch and a forerunner rope, which may comprise e.g. a rope or wire or chain, that may be arranged to lower the forerunner rope to a load-bearing rope to catch the load-bearing rope and pull it from an upper position of the second uppermost section and to an upper position of the uppermost section of the tower. The winch may e.g. be a transportable winch that may be configured to be placed on top of the uppermost section of the tower. The winch of the rope catching device may be connected to the uppermost section prior to installation of the uppermost section. Alternatively, the winch of the rope catching device may be configured to be placed at a lower portion of the tower, e.g. at a base of the tower. In an embodiment with the winch of the rope catching device placed at a lower portion of the tower, the rope catching device may comprise a pulley or something of the sort configured to be placed at the upper position of the uppermost tower.

In a second aspect, the invention may relate to a method of balancing a travelling car of an apparatus for performing at least a part of an operation to install a wind turbine, wherein the method comprises the step of:
providing the apparatus comprising the travelling car on an installed part of a wind turbine, wherein the travelling car comprises a device for balancing the travelling car, wherein the device for balancing the travelling car comprises a weight movably connected to the travelling car;
moving the weight to balance the travelling car.

The weight may be moved to offset a shift in a force affecting the travelling car, wherein the shift in the force may cause an imbalance of the travelling car.

This step may typically be performed by an operator or automatically as a response to actions or forces acting upon the travelling car that may affect the balancing of the travelling car. For example, the step may be performed following or while moving an item or section of a tower carried by the travelling car into a position for installation of the item or section of the tower, or in response to forces of wind or waves affecting the travelling car directly or indirectly.

The weight may be part of a force-altering device. The step may comprise using the force-altering device for altering a force acting on the travelling car. The apparatus may be the apparatus according to the first aspect of the invention

The step of moving the weight to balance the travelling car may comprise moving a plurality of weights to balance the travelling car. The apparatus may comprise one or more drive systems to which the weight or plurality of weights may be movably connected. Balancing the travelling car may involve altering a centre of gravity of the travelling car. The centre of gravity may be alterable along one axis, two axes or three axes, depending on the number of movable weights and on how many axes the movable weight or weights can be moved along on the drive systems. The step of moving a weight to balance the travelling car may be a step of moving a weight along an axis to balance the travelling car. The weight may be a first weight. The step of moving a weight to balance the travelling car may be a step of moving a first weight along a first axis, of moving a second weight along a first axis, of moving a third weight along a first weight, of moving a first and a second weight along a first axis, of moving a first and a second weight along a first and a second axis respectively, of moving a first and a second and a third weight along a first and a second and a third axis respectively, of moving a first and a second weight along a first axis and a third weight along a second axis, of moving a first weight along a first and a second axis and a second weight along a third axis. The step may be a step of moving any one or more of a plurality of weights along any one or more of a plurality of axis. The step may be a step of moving any one or more of a plurality of weights arranged to be moved along a first axis along the first axis, of moving any one or more of a plurality of weights arranged to be moved along a second axis along the second axis, and/or of moving any one or more of a plurality of weights arranged to be moved along a third axis along the third axis. The step may be a step of moving any one or plurality of weights arranged to be moved along a plurality of axis along one or more of the plurality of axis, and/or moving any other one or more of a plurality of other weights arranged to be moved along one or more axis along any one or more of the one or more axis.

The method may further comprise a step of pulling in or letting out a wire rope to balance the travelling car. The rope may be, e.g. one or more of the load-bearing ropes or another rope or wire connecting the travelling car to a part of the wind turbine.

The device for balancing the travelling car may have further use for balancing the tower of the wind turbine. The method may comprise the step of using the device for balancing the travelling car to stabilise or balance the tower. This may be advantageous to reduce a movement of a part of the tower, such as a swinging of the tower.

The apparatus may comprise a device for obtaining information related to a swinging of the tower. The device for obtaining information related to the swinging of the tower may be configured to provide said information to an operator via a computer device having a user interface and/or to the controller of the device for balancing the travelling car. The device for obtaining information related to the swinging of the tower may comprise e.g. an accelerometer and/or an anemometer and/or any other relevant equipment for obtaining relevant information.

Any one or all devices for obtaining information may be connected to the controller and/or to the computer device having the user interface. The connection may be wireless or wired. The information obtained by the device for obtaining information related to the swinging of the tower may be provided to the device for balancing the travelling car and used in the step of using the device for balancing the travelling car to stabilise or balance the tower. The information may be used automatically by an automatic controller of the device for balancing the travelling car. The information may be provided to an operator via the user interface. The device for balancing the travelling car may then be controlled fully automatically by the controller, partly by the controller and partly by the operator, or fully by the operator. The apparatus may comprise a controlling device to be operated by the operator. The controlling device may be configured to be or be connected to the device for balancing the travelling car, either wirelessly or by wired connection. In embodiments of the invention, the controlling device comprises a programmable logic system and a motion reference unit.

The apparatus may further comprise a data logging device for logging obtained information. The data logging device may be configured to be connected to one or more of the controller, the computer device, and the devices for obtaining information, either wirelessly or by wired connection. The apparatus may further comprise a monitoring device for monitoring one or more actions or activities. The monitoring device may comprise e.g. one or more cameras or sound recorders and may be configured to be connected to e.g. the computer device or the data logging device.

The travelling car and/or any other part of the apparatus requiring power to operate, may be configured to receive power from a power source on the ground or from a remote power source. In some embodiments, one or more parts of the apparatus may be configured to receive power from a power source carried by the travelling car, or a power source arranged on or in a part of the wind turbine. The apparatus may comprise the power source. The power source may be e.g. a battery or a diesel generator. In embodiments where the travelling car comprises a battery as a power source, the battery may be rechargeable and then typically, but not necessarily exclusively, be recharged when the travelling car is lowered to the base of the wind turbine.

In embodiments of the invention, one or more of the parts herein described as configured or arranged to or for something may be in the state it is configured or arranged to or for. E.g. the device for selectively raising or lowering the travelling car that is arranged to connect the travelling car to an uppermost installed section of the tower may in an embodiment be connecting the travelling car to an uppermost installed section of the tower, one or more parts of the apparatus that may be configured to receive power from a power source carried by the travelling car may in an embodiment be connected to the power source carried by the travelling car to receive power from said power source, and/or the adapter flange that may be configured to be attached to the top of a section for the tower for the wind turbine may be attached to the top of the section for the tower for the wind turbine.

### BRIEF DESCRIPTION OF THE DRAWINGS

In the following is described examples of preferred embodiments illustrated in the accompanying drawings, wherein:

FIGS. 1 to 16 illustrates parts of an operation to install a wind turbine by use of an embodiment of the apparatus according to the first aspect of the invention and by applying an embodiment of the method according to the second aspect of the invention, as well as the apparatus according to the first aspect of the invention;

FIG. 17 illustrates an alternative base for the wind turbine and a landing frame for the travelling car;

FIG. 18 illustrates an alternative embodiment of the travelling car.

### DETAILED DESCRIPTION OF THE DRAWINGS

Note that the embodiments shown in the figures are mere examples of the invention, and that they are not necessarily drawn to scale. Other embodiments being configured differently from those shown in the figures may be within the scope of the invention according to the claims.

The illustrations show a wind turbine at different points in time during an installation of the wind turbine. It will be described in the following some steps that may have been carried out from one point illustrated in a figure to the next point illustrated in the next figure. Each of these steps may be part of one or more embodiments of the method according to the second aspect of the invention. The following will also include a description of a possible embodiment of the apparatus according to the first aspect of the invention.

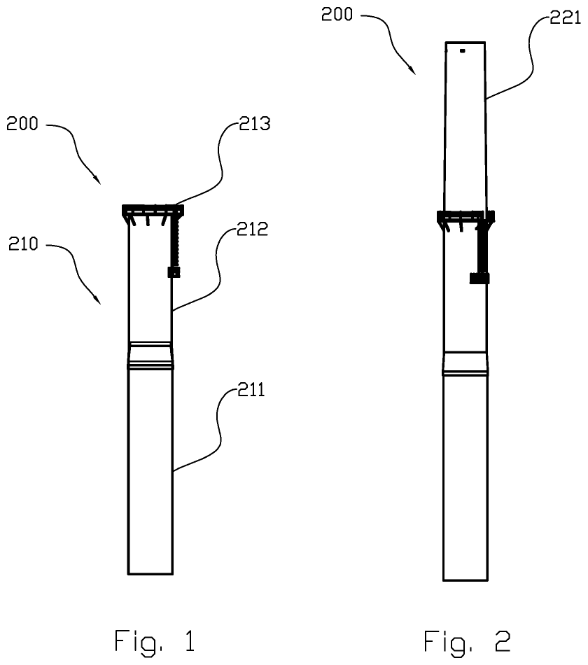

FIG. 1 shows an embodiment of a base 210 for a wind turbine 200. The base 210 comprises a foundation piece 211 and a transition piece 212, the transition piece 212 having a base working platform 213. The method according to the second aspect of the invention may include the step of providing the base 210. In other embodiments, the base 210 may be of another type, e.g. any other type of base known from the prior art.

FIG. 2 shows the same wind turbine 200, with the addition of a base section 221 of the tower 220 of the wind turbine 200. The base section 221 may typically, but not necessarily, be installed atop the transition piece 212 by use of a crane device (not shown).

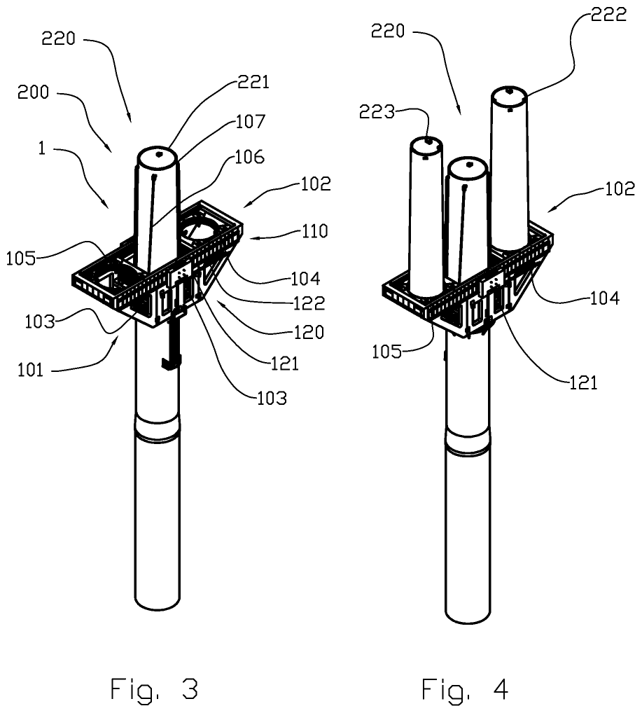

FIG. 3 shows the wind turbine 200, after further steps of an embodiment of the method. The travelling car 101 has been movably connected to the tower 220. Prior to the installation of the travelling car 101, a resting flange (not shown) may have been installed. The travelling car 101 may typically have been connected to the tower 220 one half at a time by use of a crane device (not shown), with a first half of the travelling car 101 connected to and supported by the tower 220 by use of wires (not shown) first, with a second half subsequently connected to the tower 220 and the first half of the travelling car 101.

Near a top side of the base section 221 of the tower 220, it has a set of lifting lugs 107. The travelling car 101 has a deck 102 and a plurality of winches 103 on an underside of the deck 102. The particular embodiment of the travelling car 101 further has a first and a second movable part 104, 105 of the deck 102, wherein each of the first and the second movable part 104, 105 are configured for carrying an item to be installed as part of the wind turbine 200. A plurality of load-bearing ropes 106 connects the travelling car to an upper portion of the base section 222 of the tower 220 by connecting the plurality of winches 103 to the set of lifting lugs 107.

Furthermore, the travelling car 101 has a device for balancing the travelling car 101. The device for balancing the travelling car 110 includes a force-altering device 120 having a weight 121 and a track 122, wherein the weight 121 is movably connected to a track 122 of a drive system 122. The weight 121 may typically be connected to the track 122 subsequently of installation of the travelling car 101 to the tower 220. Moving the weight 121 along the track 122 will alter a force of gravity affecting the travelling car 101, by altering the position of the weight 121 and thereby the position at which the force of gravity acting on the weight 121 acts on the travelling car 101.

In FIG. 4, a first and a second section 222, 223 for the tower 220 has been placed securely on the first and the second movable part 104, 105 of the deck 102 respectively. The first and the second movable part 104, 105 is, in FIG. 4, in their initial positions. They may have been placed there by use of a crane (not shown), which may be the same crane that was used for connecting the travelling car 101 to the tower 220.

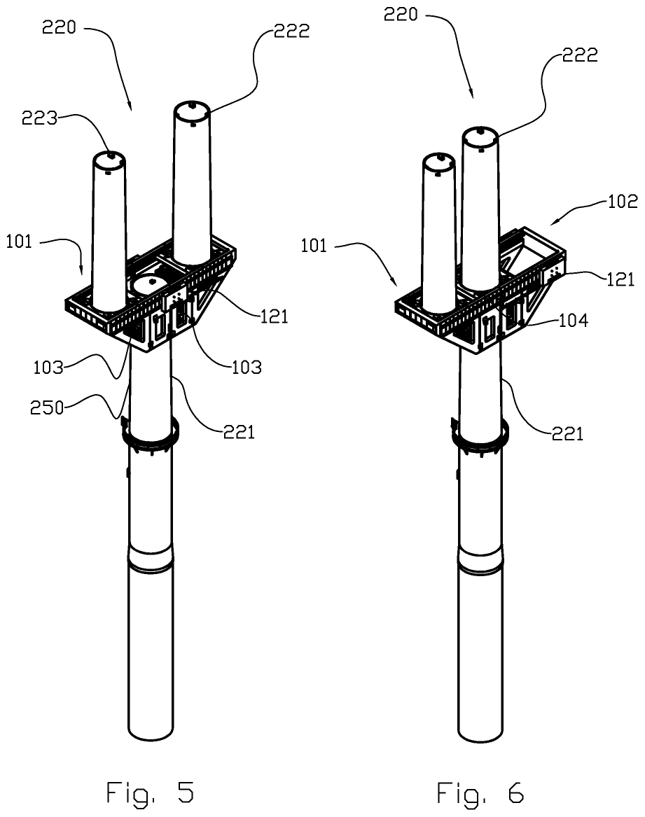

FIG. 5 shows the travelling car 101, carrying the first and the second section 222, 223 for the tower 220, in an elevated position on the tower 220. In the elevated position, the deck 102 is slightly above the, at the time, uppermost installed section of the tower 250. The uppermost section of the tower 250 at the point of the installation shown in FIG. 5 is the base section of the tower 221. To elevate the travelling car 101, the winches 103 have been used to pull in load-bearing rope 106. When the travelling car 101 is in said elevated position, it is ready for installation of the first section 222.

In FIG. 6, the first movable part 104 of the deck 102 has been moved to a central position of the travelling car 101, directly above the base section 221 of the tower 220, to install the first section 222 of the tower 220 atop the base section 221 of the tower 220. To balance the travelling car 101 after/while moving the first section 222 to the central position, the weight 121 has been moved to the side of the travelling car 101 where the first section 222 was held prior to it being moved centrally. Moving the weight 121 in the opposite direction of the first section 222, offsets an imbalance that would otherwise have been caused by the movement of the first section 222.

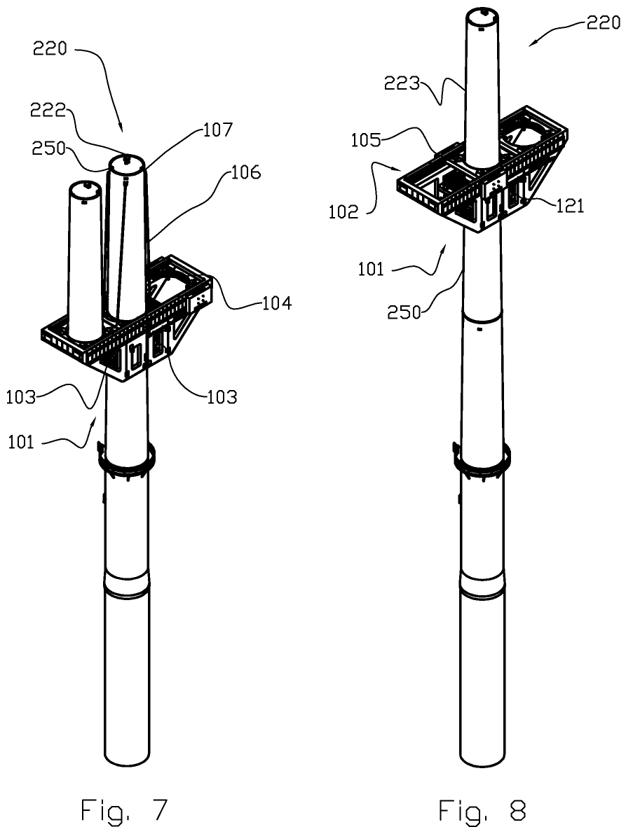

A typical next step of the installation may be to slightly lower the travelling car 101 along the tower 220. Subsequently of said lowering, the travelling car may be locked into the slightly lowered position, e.g. by bolting it to the first section 222, the now uppermost section 250 of the tower 220. See FIG. 7.

When the travelling car 101 has been secured in position, the first movable part 104 of the deck 102 may be moved back to its initial position. If necessary, the weight 121 may be moved slightly towards the middle to offset the shift in weight distribution caused by the movement of the first movable part 104.

As can be further seen in FIG. 7, the uppermost installed section of the tower 250 has been arranged with a set of lifting lugs 107. Furthermore, the travelling car 101 has been connected to an upper part of the uppermost tower section 250 by use of load-bearing ropes 106 connected to the winches 103 of the travelling car 101.

Following the connection of the travelling car 101 to the upper part of the uppermost tower section 250, the travelling car 101 is again elevated to a position slightly above the uppermost tower section 250. When the travelling car 101 is in said elevated position, the second movable part 105 of the deck 102 is moved centrally, as seen in FIG. 8, to install the second section 223 of the tower 220 atop the uppermost installed section 250 of the tower 220.

After installation of the second section 223 of the tower 220, the second section 223 becomes the uppermost installed section of the tower 250. The travelling car 101 is then lowered slightly and secured in position by bolting to the tower 220. When secured, the second movable part 105 of the deck 102 of the travelling car 101 is moved back to its initial position.

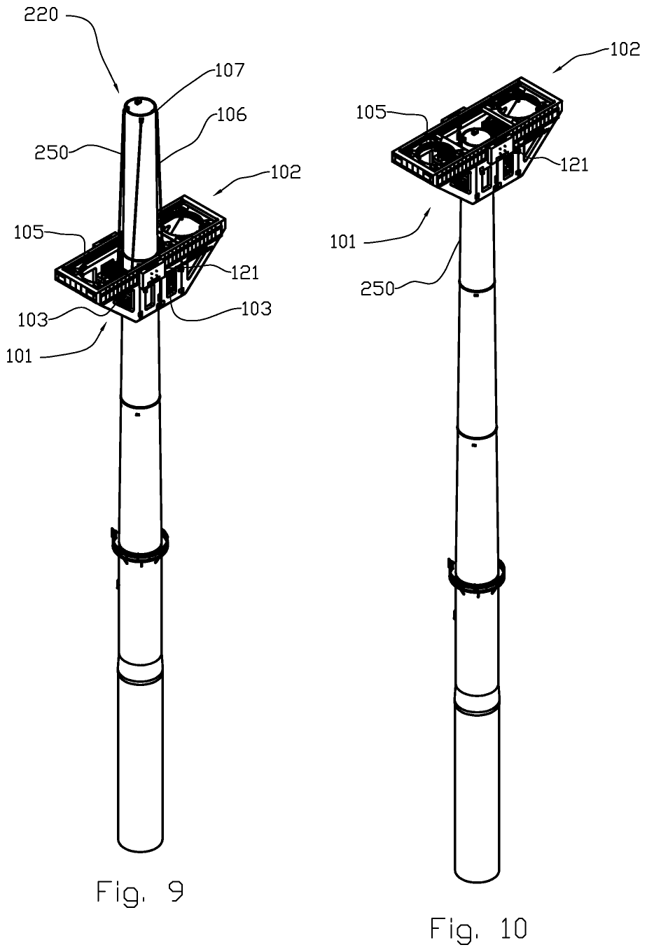

As seen in FIG. 9, the new uppermost section 250 of the tower 220 has a set of lifting lugs 107. The travelling car 101 is then connected to the lifting lugs 107, and thereby to uppermost section 250 of the tower, 220 by load-bearing ropes 106 connecting the winches 103 of the travelling car 101 to the lifting lugs 107.

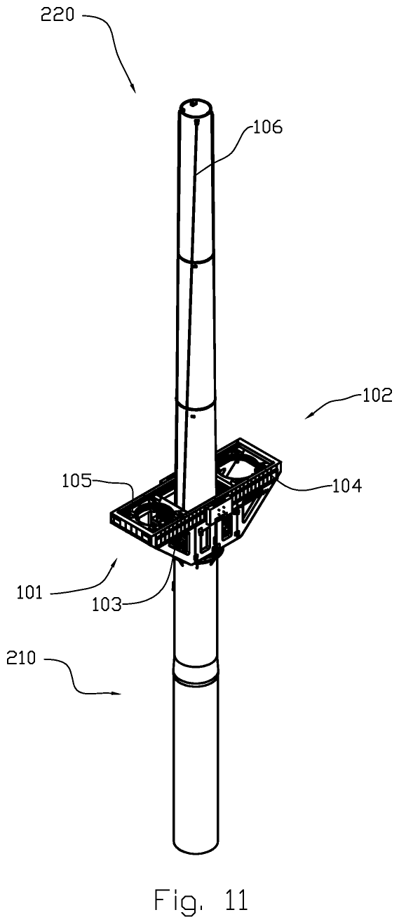

FIG. 10 shows how, after having connected the travelling car 101 to the uppermost section 250, the travelling car 101 may then be elevated to a position where the deck 102 of the travelling car 101 is above the uppermost section 250, and where the second moving part 105 of the deck 102 may be moved back to its initial position.

In FIGS. 8 to 10 it can further be seen how the weight 121 is moved to balance the travelling car 101. When the second movable part 105 of the deck 102 is moved centrally with the second section 223, the weight is placed a bit off-centre towards the side of the second movable part 105 (FIG. 8). When the second movable part 105 is moved back to its initial position, the weight 121 is moved into a central position.

As the travelling car 101 is no longer carrying a load to be installed, it is lowered, by letting out load-bearing rope 106 by use of the winches 103, down to the base 210 for the wind turbine. Both the first and the second moving part 104, 105 of the deck 102 of the travelling car 101 is back in their initial positions, ready to receive a new load to be carried. The travelling car 101 can be seen in FIG. 11, ready to receive new items to carry to the top of the tower 220.

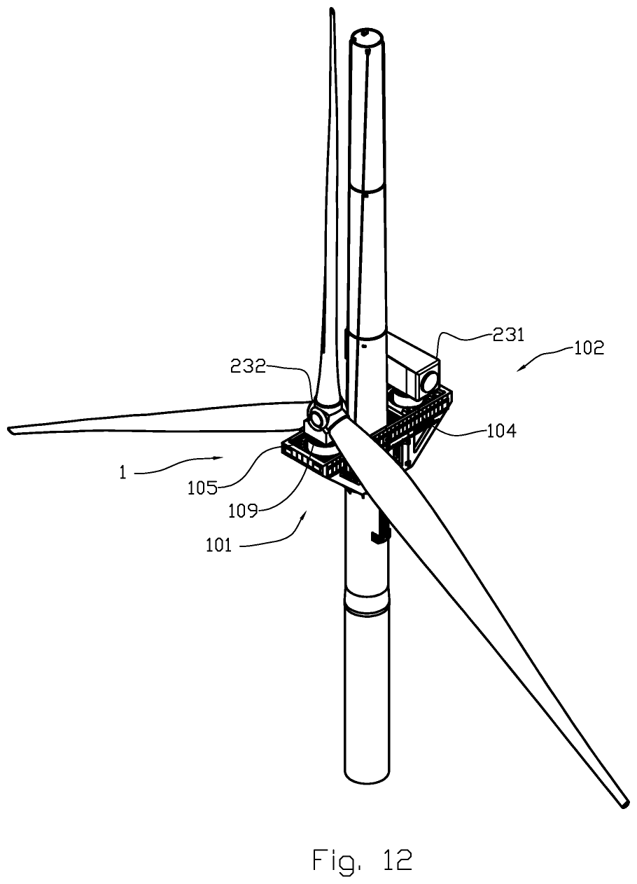

The embodiment of the apparatus 1 and the method may additionally be for installation of a nacelle 231 and a propeller with rotor blades 232. FIG. 12 shows the nacelle 231 mounted on the first moving part 104 of the deck 102 of the travelling car 101, and the propeller with rotor blades 232 mounted on a seat 109 for the propeller with rotor blades 232 on the second moving part 105 of the deck 102.

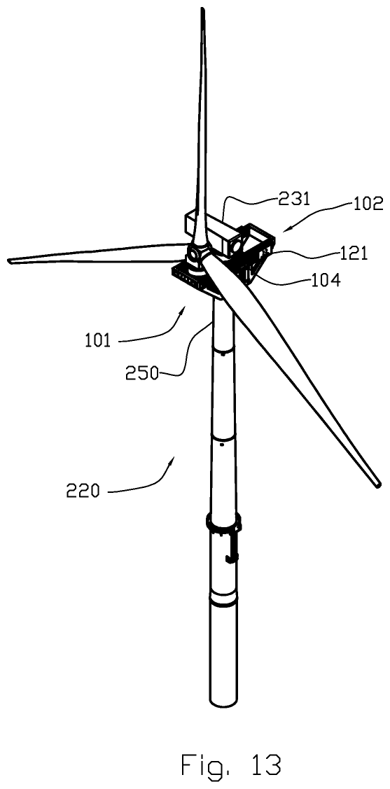

In FIG. 13, the travelling car 101 has been pulled to the top of the tower 220, to a position where the deck 102 is slightly above the top of the uppermost section 250 of the tower 220. Furthermore, the first moving part 104 of the deck 102 has been moved centrally, to move the nacelle 231 directly above the top of the uppermost section 250 to install the nacelle 231 atop the uppermost section 250. To balance the travelling car during and/or following the moving of the nacelle 231, the weight has been shifted far towards the side of the travelling car 101 where the nacelle 231 was previously held.

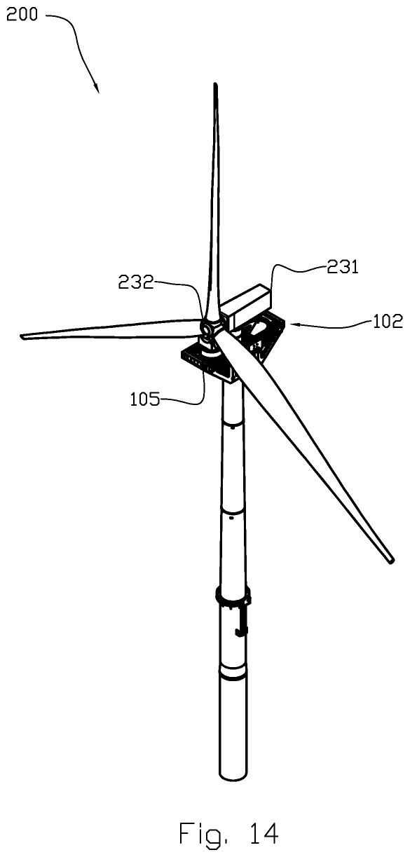

In FIG. 14, the nacelle 231 has been rotated 90 degrees and made ready for installation of the propeller with rotor blades 232. The second moving part 105 of the deck 102 is then moved to move the propeller with rotor blades 232 so as to allow it to connect with and to be installed in connection with the nacelle 231.

When the propeller with rotor blades 232 has been installed, the wind turbine 200 may be fully installed, or the part of the installation of the wind turbine 200 that involves use of the apparatus 1 may be completed.

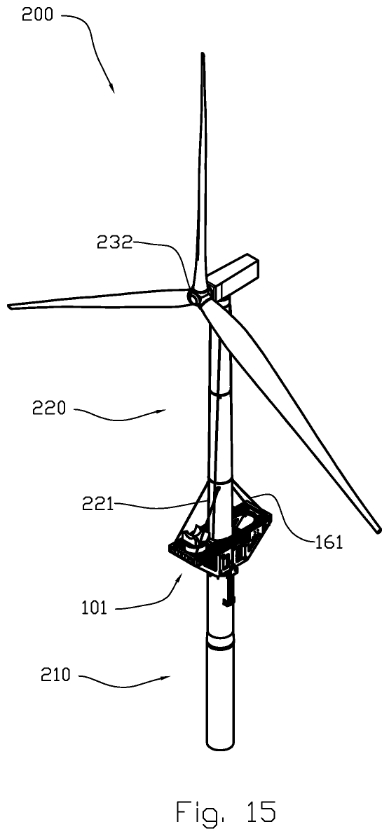

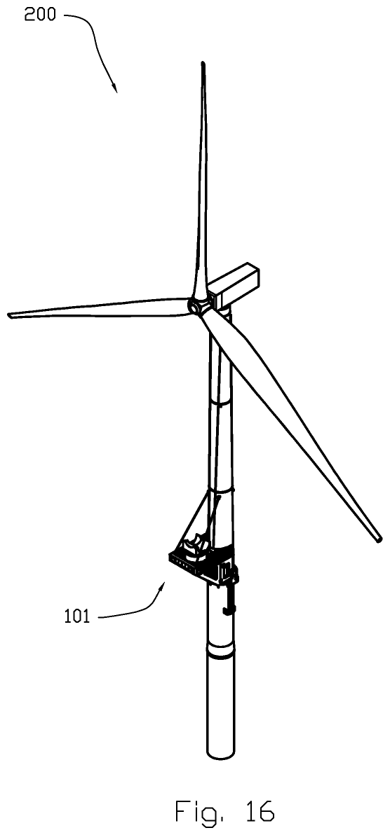

FIGS. 15 and 16 shows an embodiment of a removal of the travelling car 101 from the wind turbine 200. The method may include the removal of the travelling car 101. The travelling car 101 is lowered to the base 210 for the wind turbine 200 and connected to the base section 221 of the tower 220 by connection wire ropes 161 extending from the travelling car 101 to the base section 221.

In FIG. 16, a first half of the travelling car 101 has been removed. The second half still remains on the wind turbine 200 in the figure but is ready for removal.

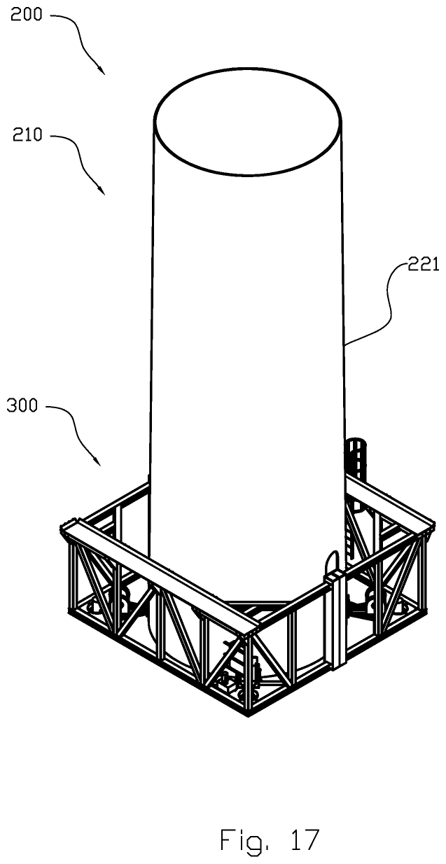

FIG. 17 illustrates an alternative embodiment of a base 210 for a wind turbine 200, with a base section of the tower 221. Further illustrated in FIG. 17 is a landing frame 300 for a travelling car 101. The apparatus may comprise the landing frame 300. The landing frame 300 may typically be configured for supporting the travelling car 101 when the travelling car is sitting at the base 210 of the wind turbine 200, for installation of the travelling car 101 onto the tower, etc.

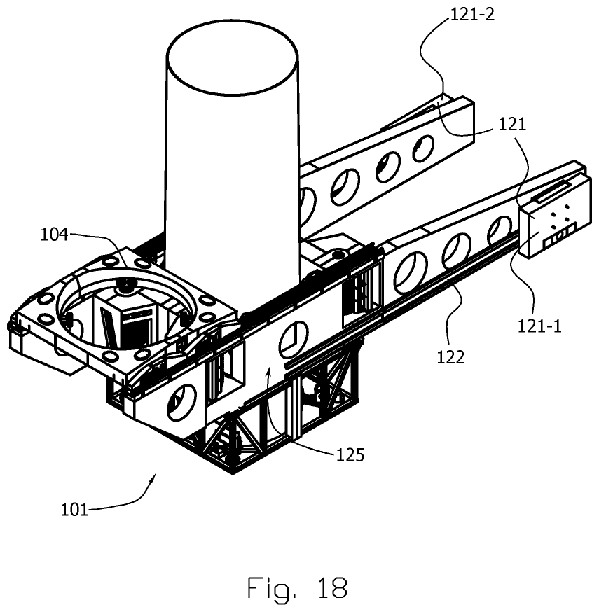

FIG. 18 illustrates a possible one of many conceivable embodiments of the travelling car 101. The embodiment shown in FIG. 18 only has one movable portion of the deck (a first movable portion of the deck 104), for receiving and moving an item to be installed as part of the wind turbine 200. The travelling car 101 has a weight 121 movably connected to a rack and pinion travelling system 122, for moving the weight 121 substantially horizontally. FIG. 18 shows an embodiment having two weights 121-1, 121-2, one on each side of the travelling car 101, each weight 121-1, 121-2 being movable mounted to the travelling car 101 via a respective track 122 (as part of the rack and pinion travelling system).

FIG. 18 further illustrates the earlier-described device 125 for obtaining information relevant for balancing of the travelling car 101, which may comprise e.g. a motion reference units, an electronic level, an accelerometer, an anemometer, and/or a force gauge and/or one or more other such equipment. The device for obtaining the information relevant for balancing of the travelling car may comprise one or more of any of the above-mentioned equipment, and is provided at one or more places on the travelling car 101.

An embodiment of the travelling car 101 such as the one shown in FIG. 18 may in theory be configured for being connected to the uppermost section 250 of the tower by a single load-bearing rope 106 and employ a single winch 103 for raising or lowering the travelling car 101.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1.-11. (canceled)

12. An apparatus for performing a part of an operation to install a wind turbine,
wherein the wind turbine comprises a tower,
wherein the apparatus comprises a travelling car for travelling up and down along the tower of the wind turbine and for carrying an item to be installed as part of the wind turbine,
wherein the travelling car comprises a device for balancing the travelling car, and
wherein the device for balancing the travelling car comprises a weight configured to be movably connected to the travelling car
i) for allowing keeping the travelling car balanced under exposure to a force or
ii) for avoiding, correcting or reducing a shift in a center of gravity of the travelling car,
wherein the device for balancing the travelling car comprises a plurality of weights and wherein at least one weight is movably connected to each one of a plurality of drive systems arranged along at least two of an x-axis, a y-axis and a z-axis, wherein the x-axis is a substantially horizontal axis, the y-axis is a substantially vertical axis and the z-axis is a substantially horizontal axis substantially perpendicular to the x-axis when the apparatus is in operational use.

13. The apparatus according to claim 12, wherein the weight is movably mounted to the travelling car via a track of a drive system.

14. The apparatus according to claim 12, wherein the weight is a solid weight made from a heavy material, with a density of more than 5 g/cm3.

15. The apparatus according to claim 12, wherein the device for balancing the travelling car comprises a plurality of weights.

16. The apparatus according to claim 12, wherein the device for balancing the travelling car comprises a rack and pinion drive system, and wherein the weight or plurality of weights is movably connected to the travelling car via the rack and pinion drive system.

17. The apparatus according to claim 12, wherein the apparatus comprises a device for obtaining information relevant to the balancing of the travelling car.

18. A method of balancing a travelling car of an apparatus for performing at least a part of an operation to install a wind turbine, wherein the method comprises the step of:
providing the apparatus comprising the travelling car on an installed part of a wind turbine, wherein the travelling car comprises a device for balancing the travelling car, wherein the device for balancing the travelling car comprises a weight movably connected to the travelling car, wherein the device for balancing the travelling car comprises a plurality of weights and wherein at least one weight is movably connected to each one of a plurality of drive systems arranged along at least two of an x-axis, a y-axis and a z-axis, wherein the x-axis is a substantially horizontal axis, the y-axis is a substantially vertical axis and the z-axis is a substantially horizontal axis substantially perpendicular to the x-axis when the apparatus is in operational use;
moving the weight to balance the travelling car.

19. The method according to claim 18, wherein the apparatus is an apparatus for performing a part of an operation to install a wind turbine,
wherein the wind turbine comprises a tower,
wherein the apparatus comprises a travelling car for travelling up and down along the tower of the wind turbine and for carrying an item to be installed as part of the wind turbine,
wherein the travelling car comprises a device for balancing the travelling car, and
wherein the device for balancing the travelling car comprises a weight configured to be movably connected to the travelling car
i) for allowing keeping the travelling car balanced under exposure to a force or
ii) for avoiding, correcting or reducing a shift in a center of gravity of the travelling car,
wherein the device for balancing the travelling car comprises a plurality of weights and wherein at least one weight is movably connected to each one of a plurality of drive systems arranged along at least two of an x-axis, a y-axis and a z-axis, wherein the x-axis is a substantially horizontal axis, the y-axis is a substantially vertical axis and the z-axis is a substantially horizontal axis substantially perpendicular to the x-axis when the apparatus is in operational use.

20. The method according to claim 18, wherein the step of moving the weight to balance the travelling car is a step of moving a plurality of weights to balance the travelling car.

21. The method according to any one of claim 18, wherein the apparatus comprises a device for obtaining information relevant to the balancing of the travelling car, wherein the step of moving the weight or the plurality of weights is a performed automatically in response to input from a device for obtaining information relevant to the balancing of the travelling car.

22. The apparatus according to claim 13, wherein the weight is a solid weight made from a heavy material, with a density of more than 5 g/cm3.

23. The method according to claim 19, wherein the step of moving the weight to balance the travelling car is a step of moving a plurality of weights to balance the travelling car.

24. The method according to any one of claim 19, wherein the apparatus comprises a device for obtaining information relevant to the balancing of the travelling car, wherein the step of moving the weight or the plurality of weights is a performed automatically in response to input from a device for obtaining information relevant to the balancing of the travelling car.

25. The method according to any one of claim 20, wherein the apparatus comprises a device for obtaining information relevant to the balancing of the travelling car, wherein the step of moving the weight or the plurality of weights is a performed automatically in response to input from a device for obtaining information relevant to the balancing of the travelling car.
